(19) United States
(12) Patent Application Publication
(10) Pub. No.: US 2023/0359085 A1
(43) Pub. Date: Nov. 9, 2023

(54) OPTICAL SHEET, BACKLIGHT UNIT, AND LIQUID CRYSTAL DISPLAY DEVICE

(71) Applicant: KEIWA INCORPORATED, Chuo-ku (JP)

(72) Inventors: Yuki MATSUNO, Tokyo (JP); Taihei SUZUKI, Tokyo (JP); Chengheng TSAI, Tokyo (JP)

(73) Assignee: KEIWA INCORPORATED, Chuo-ku (JP)

(21) Appl. No.: 18/245,984

(22) PCT Filed: Aug. 31, 2021
(86) PCT No.: PCT/JP2021/031840

§ 371 Date: Mar. 20, 2023

(30) Foreign Application Priority Data
Sep. 29, 2020 (JP) 2020-163602

(51) Int. Cl. G02F 1/1335; G02F 1/13357

(52) U.S. Cl. CPC G02F 1/133614; G02F 1/133607; G02F 1/133603

(57) ABSTRACT

An aspect of the present invention is directed to an optical sheet including a color conversion layer containing a phosphor, and a plurality of light diffusion particles fixedly attached on at least one surface of the color conversion layer.

### TECHNICAL FIELD

The present invention relates to an optical sheet, a backlight unit, and a liquid crystal display device.

### BACKGROUND ART

Liquid crystal display devices (liquid crystal displays) have been widely used as a display device for various information apparatus such as a smartphone and a tablet. As a backlight used in a liquid crystal display, there is a direct-lit type which has a plurality of light sources to be provided to a rear of a liquid crystal panel, for example.

In the direct-lit backlight, a light emitting diode (LED) element is often used as the light source, and for example, a so-called blue LED element emitting blue light is used. In the case where an LED element is used as the light source, a light emitter is used, which performs color conversion of the light emitted from the light source to whitish light, and outputs it.

As a light emitter capable of color conversion, for example, there is a backlight unit disclosed in Patent Literature 1. Patent Literature 1 discloses a backlight unit including a surface emission part which performs a planar emission of blue light, a sheet-type wavelength conversion member having a wavelength conversion layer which, upon entrance of the blue light emitted from the surface emission part, outputs light on a longer wavelength side than the blue light while transmitting a part of the blue light, an assembly of retroreflective members which is provided opposite to the surface emission part across the sheet-type wavelength conversion member, and a reflective plate which is provided opposite to the sheet-type wavelength conversion member across the surface emitting part, the assembly of retroreflective members having a blue light reflectance higher than 70%.

Patent Literature 1 mentions that thinning of the unit and output of white light having a good hue are achievable. Further, Patent Literature 1 mentions that the output of white light is achievable by increasing the excitation light reflectance of the assembly of retroreflective members, and that an exemplary assembly of retroreflective members includes a prism sheet, a reflective polarizing plate, and a selective reflection layer selectively reflecting blue light.

### CITATION LIST

### Patent Literature

Patent Literature 1: International Patent Publication No. 2016/051745

### SUMMARY OF INVENTION

An object of the present invention is to provide an optical sheet which is able to perform a suitable color conversion, a backlight unit including the optical sheet, and a liquid crystal display device including the backlight unit.

According to an aspect of the present invention, an optical sheet includes a color conversion layer containing a phosphor, and a plurality of light diffusion particles fixedly attached on at least one surface of the color conversion layer.

The foregoing and other objects, features, and advantages of the present invention will be clarified by the following detailed description.

### BRIEF DESCRIPTION OF DRAWINGS

FIG. 1 is a schematic cross-sectional view showing a configuration of an optical sheet according to an embodiment of the present invention.

FIG. 2 is a schematic cross-sectional view showing a configuration of another optical sheet according to the embodiment of the present invention.

FIG. 3 is a schematic cross-sectional view showing a configuration of a still another optical sheet according to the embodiment of the present invention.

FIG. 4 is a schematic cross-sectional view showing a configuration of a still another optical sheet according to the embodiment of the present invention.

FIG. 5 is a schematic cross-sectional view showing a configuration of a backlight unit including the optical sheet according to the embodiment of the present invention.

FIG. 6 is a schematic cross-sectional view showing a configuration of a liquid crystal display device including the backlight unit shown in FIG. 5.

FIG. 7 is a graph showing a relationship between a kind of light diffusion particles fixedly attached on an optical sheet and a chromaticity.

FIG. 8 is a graph showing a relationship between a configuration of an optical sheet and a chromaticity.

### DESCRIPTION OF EMBODIMENTS

For a direct-lit backlight, for example, it is conceivable to perform color conversion of light emitted from an LED element that is the light source into whitish light by arranging, between the light source and a prism sheet, an optical sheet which transmits the light emitted from the light source to thereby convert the color of the transmitted light. It is conceivable to make the optical sheet capable of color conversion contain phosphors. Specifically, for example, the use of an optical sheet containing β-SiAlON as a green phosphor and KSF as a red phosphor enables a color reproductivity higher than 90% according to DCI-P3 standard. On the other hand, it is necessary that such optical sheet is highly filled with phosphors in order to obtain white light through transmission of light emitted from an LED element. However, since the phosphors such as β-SiAlON and KSF are very expensive, when an optical sheet is highly filled with phosphors so that the optical sheet suitably converts blue light to white light, the obtained optical sheet is liable to be very expensive. For this reason, there is demand for an optical sheet able to perform a suitable color conversion even with a reduced amount of phosphor used. In other words, there is demand for an optical sheet having a color conversion efficiency high enough to perform a suitable color conversion even with a relatively low content of the phosphor.

It is conceivable to make a backlight which can emit white light by providing a prism sheet, a reflective polarizing plate, a selective reflection layer, and the like without relying upon an optical sheet capable of color conversion with an increased amount of phosphor used, as the backlight unit disclosed in Patent Literature 1. Patent Literature 1 mentions that the assembly of retroreflective members may be optically in contact with the sheet-type wavelength conversion member. However, in the invention disclosed in Patent Literature 1, the sheet-type wavelength conversion member includes a wavelength conversion layer sandwiched by two transparent substrates. Thus, it is not an optical sheet in which an assembly of retroreflective members and a wavelength conversion layer are integrally combined with each other. In other words, in the invention disclosed in Patent Literature 1, the assembly of retroreflective members and the sheet-type wavelength conversion member can be seen to be provided separately.

On the other hand, there is demand for a thinner backlight unit. Therefore, an optical sheet having an excellent color convertibility is demanded as an optical sheet capable of color conversion. The prism sheet and the like can be thinned by providing an optical sheet having an excellent color convertibility, which consequently enables the thinning of the backlight unit. For this reason, there is demand for an optical sheet so excellent in the color convertibility that a suitable color conversion is achievable without relying upon an increase in the content of the phosphor.

As a result of various studies, the present inventors have found that the above-described object of providing an optical sheet which can perform a suitable color conversion, a backlight unit including the optical sheet, and a liquid crystal display device including the backlight unit can be achieved by the present invention described below.

Hereinafter, an embodiment of the present invention will be described. However, the present invention is not limited thereto.

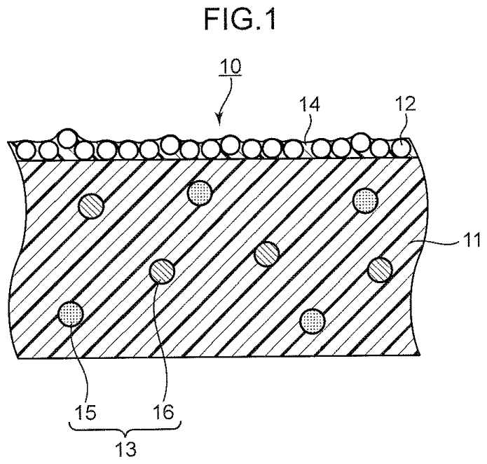

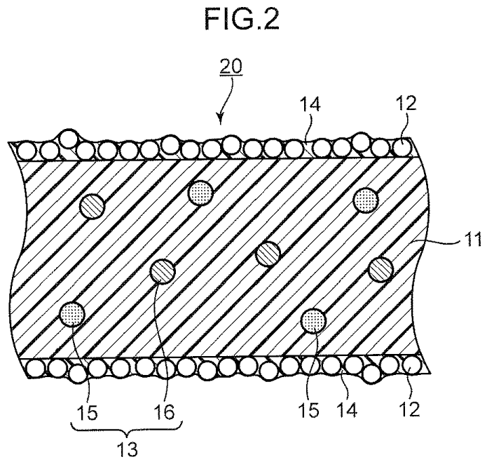

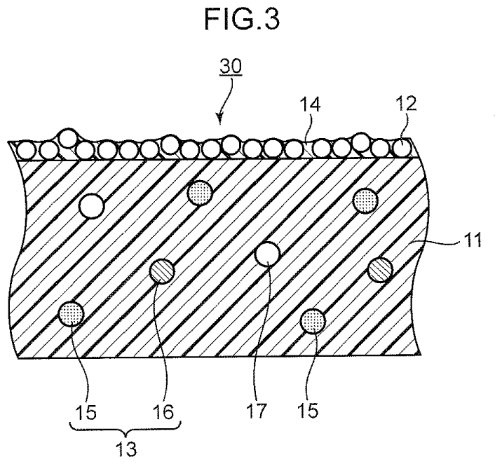

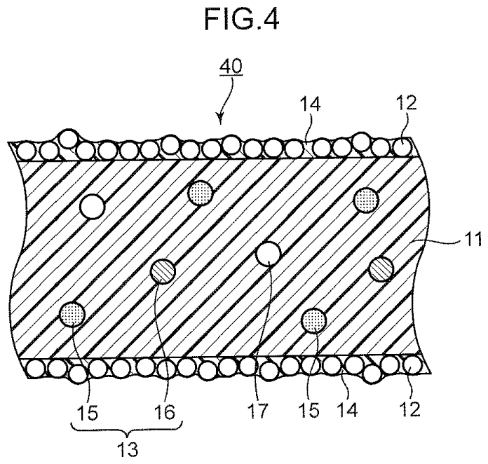

An optical sheet according to an embodiment of the present invention includes a color conversion layer containing a phosphor, and a plurality of light diffusion particles fixedly attached on at least one surface of the color conversion layer. As an example of the optical sheet, as shown in FIG. 1, there is an optical sheet 10 including a color conversion layer 11 containing a phosphor 13 and a plurality of light diffusion particles 12 fixedly attached on at least one surface of the color conversion layer 11. As another example of the optical sheet, as shown in FIG. 2, there is an optical sheet 20 including a color conversion layer 11 containing a phosphor 13 and a plurality of light diffusion particles 12 fixedly attached on both of surfaces (both surfaces) of the color conversion layer 11. As shown in FIGS. 3 and 4, the color conversion layer 11 may contain not only the phosphor 13 but also a light diffusion agent 17. Specifically, the color conversion layer 11 contains the phosphor 13, and may further contain the light diffusion agent 17. FIG. 1 is a schematic cross-sectional view showing a configuration of an optical sheet (optical sheet 10) according to an embodiment of the present invention. FIG. 2 is a schematic cross-sectional view showing a configuration of another optical sheet (optical sheet 20) according to the embodiment of the present invention. FIG. 3 is a schematic cross-sectional view showing a configuration of a still another optical sheet (optical sheet 30) according to the embodiment of the present invention. FIG. 4 is a schematic cross-sectional view showing a configuration of a still another optical sheet (optical sheet 40) according to the embodiment of the present invention.

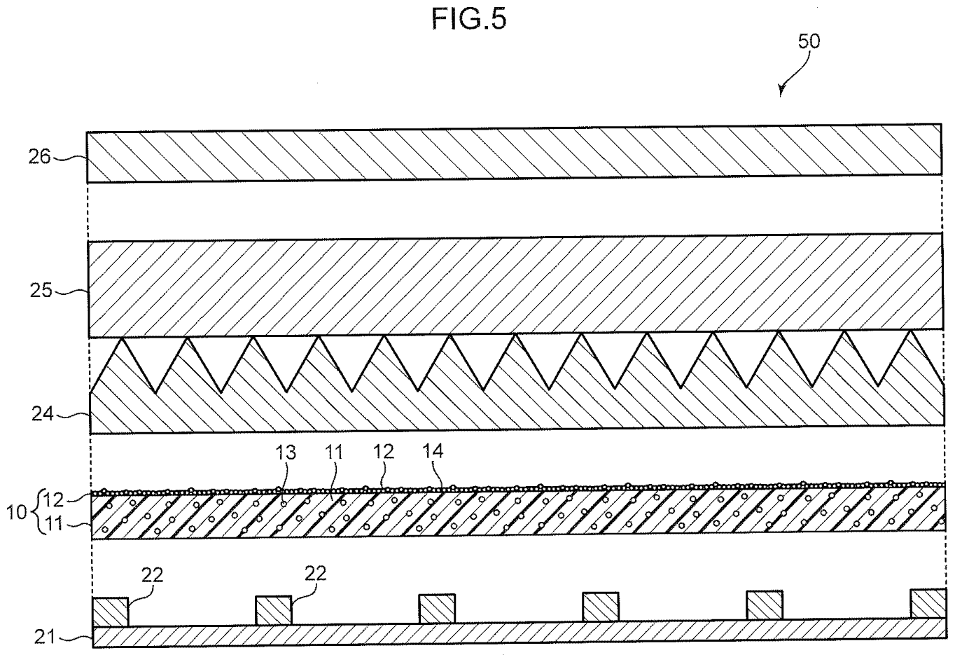

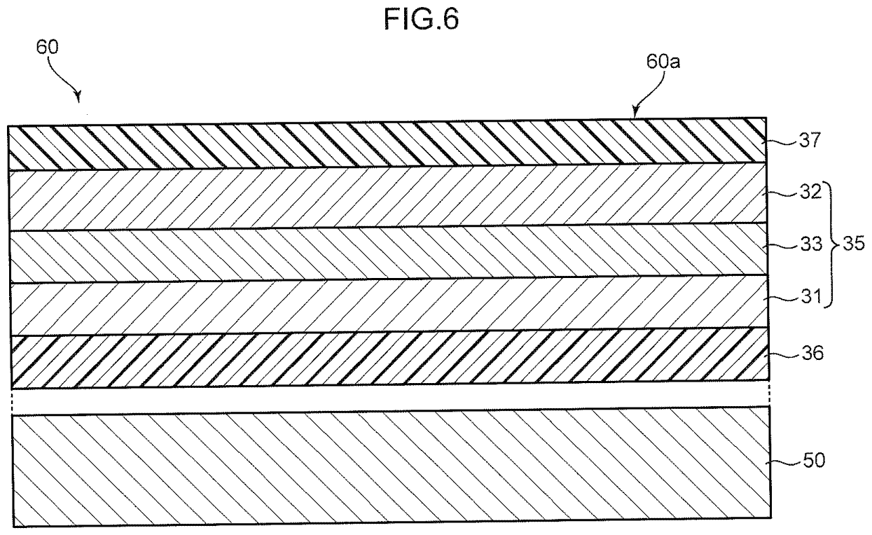

For example, the optical sheets 10, 20, 30, and 40 (hereinafter, the optical sheets 10, 20, 30, and 40 are also simply referred to as “the optical sheet”) may be used in a liquid crystal display device including a plurality of light sources separately provided to a rear of a display screen as an optical sheet arranged between the light sources and a prism sheet. More specifically, for example, as shown in FIGS. 5 and 6, in a backlight unit 50 provided in a liquid crystal display device 60, the optical sheet is arranged between a plurality of light sources 22 separately provided to the rear of the liquid crystal display device 60 and the prism sheets 24, 25. Further, when the optical sheet includes the color conversion layer 11 having one surface fixedly attached with the light diffusion particles 12 as shown in FIG. 1, it may be appreciated that the optical sheet 10 is arranged so that the color conversion layer 11 is on the light sources 22 side (on the light input side), and the light diffusion particles 12 are on the prism sheets 24, 25 side (on the light output side) as shown in FIG. 5. FIG. 5 is a schematic cross-sectional view showing a configuration of an exemplary backlight unit 50 including the optical sheet 10, which is an exemplary optical sheet according to the embodiment. FIG. 6 is a schematic cross-sectional view showing a configuration of a liquid crystal display device 60 including the backlight unit 50 shown in FIG. 5.

The optical sheet is able to perform a suitable color conversion of transmitted light owing to the light diffusion particles 12 fixedly attached on a surface of the color conversion layer 11 containing the phosphor 13. Specifically, in the optical sheet, the content of the phosphor 13 can be reduced to achieve a color conversion of the same level as that in a case where no light diffusion particle is fixedly attached on the surface thereof.

This is considered to be attributable to the followings. First, when light passes through the color conversion layer 11 provided in the optical sheet, the passing light strikes a phosphor 13 contained in the color conversion layer 11, whereby the color of the light is converted. When the light having passed through the color conversion layer 11 strikes a light diffusion particle 12 fixedly attached on a surface of the color conversion layer 11, the light is reflected. The reflected light sometimes strikes a phosphor 13 contained in the color conversion layer 11. Here, since the light reflected upon striking the light diffusion particle 12 further strikes the phosphor 13 contained in the color conversion layer 11, the striking frequency of the phosphor 13 by the light is considered to increase. The increase in the striking frequency of the phosphor 13 by the light is considered to increase the light conversion efficiency. This is the considerable reason why the optical sheet is able to perform such a suitable color conversion that a suitable color conversion is achievable even with a relatively low content of the phosphor 13.

Here, specifically, the color conversion refers to a color conversion from the blue light to whitish light by causing the optical sheet to transmit the blue light.

The light diffusion particle 12 is not limited to a particular one as long as the particle exhibits an effect of diffusing light passed through the color conversion layer 11. As the light diffusion particle 12, for example, there is a light diffusion agent, i.e., a light diffusion agent and the like that is contained in an optical sheet to thereby exhibit a light diffusion effect. The light diffusion particle 12 may be an inorganic particle or an organic particle. As the inorganic particle, for example, there are a silica particle, a titanium oxide particle, an aluminum hydroxide particle, a barium sulfate particle, and a glass bead. For example, the organic particle may be a resin bead such as an acrylic bead and a polystyrene bead. As the resin bead, for example, there are an acrylic particle, an acrylonitrile particle, a silicone bead, a polystyrene particle, a melamine particle, and a polyamide particle. The organic particle (resin bead) may also be a hollow particle. As the hollow particle, for example, there is a hollow particle (hollow styrene particle) containing styrene-based resin. A single kind among the light diffusion particles 12 may be used, or two or more kinds thereof may be used in combination. As the light diffusion particle 12, among these, the glass bead, the acrylic bead, and the hollow styrene particle are preferable, where the hollow styrene particle is more preferable.

A particle diameter of the light diffusion particle 12 is not limited to a particular one as long as a light diffusion effect can be exhibited. The particle diameter may vary also according to a kind of the light diffusion particles 12, and the like, but is preferably 0.1 to 5 μm, and more preferably 0.5 to 1 μm in terms of a volume average particle diameter. Both of a light diffusion particle 12 being excessively small and a light diffusion particle 12 being excessively large are liable to fail to perform suitable color conversion. This is considered to be attributable to the fact that, in the case the light diffusion particle 12 is excessively small, light having passed through the color conversion layer 11 provided in the optical sheet and striking a light diffusion particle 12 fixedly attached on a surface of the color conversion layer 11 is more hardly reflected. Further, it is considered to be attributable to the fact that, in the case the light diffusion particle 12 is excessively large, the light diffusion particles 12 tend to be distant from one another, and thus are more hardly hit by light having passed through the color conversion layer 11 provided in the optical sheet. Accordingly, the light diffusion particle 12 having a particle diameter within the range described above is able to make the obtained optical sheet perform more suitable color conversion. The volume average particle diameter of the light diffusion particle 12 can be measured by a generally used particle size analyzer.

Preferably, the light diffusion particle 12 is fixedly attached over the entire surface of the color conversion layer 11. The coverage of the light diffusion particles 12 may vary according to a particle diameter and the like of the light diffusion particles 12, but for example, is preferably 100% or more in terms of a ratio of an area in which the light diffusion particles 12 are present to an area of the color conversion layer 11. Specifically, the light diffusion particles 12 are preferably arranged one over another in a portion in a surface direction of the color conversion layer 11.

It is sufficient that the light diffusion particles 12 are fixedly attached on the surface of the color conversion layer 11. For example, as shown in FIGS. 1 to 4, the light diffusion particles 12 may be fixedly attached to the color conversion layer 11 by a resin (binder) 14. As the binder 14, for example, there is resin having the translucency (translucent resin). As the translucent resin being the binder 14, for example, there are acrylic resin, polystyrene, polycarbonate, a methyl methacrylate-styrene copolymer, polyethylene terephthalate, polyethylene naphlate, cellulose acetate, and polyimide. Further, as the binder 14 (the translucent resin), ultraviolet (UV)-curable resin and thermosetting resin are preferably used. As the UV-curable resin, for example, there is UV-curable acrylic resin. As the thermosetting resin, for example, there is thermosetting acrylic resin. A single kind among the binders 14 may be used, or two or more kinds thereof may be used in combination.

When the light diffusion particles 12 are fixedly attached by the binder 14, a ratio of the light diffusion particles 12 to the binder 14 (light diffusion particles/binder) is preferably from 10 to 300 mass %, more preferably from 60 to 100 mass %. When the ratio is excessively low, the content of the light diffusion particles 12 tends to be low, and an effect enhanced by the light diffusion particles 12 tends thus to be insufficient. Consequently, a color conversion efficiency of the optical sheet is hardly increased enough, and an optical sheet capable of suitable color conversion is liable to be hardly obtainable. On the other hand, when the ratio is excessively high, the content of the binder 14 tends to be low, and the light diffusion particles 12 are liable to be hardly fixedly attached thereto in a suitable manner. Accordingly, the light diffusion particles 12 can be fixedly attached by such an amount of the binder 14 as to satisfy the above range of the ratio, whereby an optical sheet able to perform a suitable color conversion is more likely obtainable.

The color conversion layer 11 is not limited to a particular one as long as the color conversion layer 11 contains a phosphor 13 and is able to transmit light as shown in FIGS. 1 to 4. As the color conversion layer 11, for example, there are a layer containing the phosphor 13 and further containing resin having the translucency (translucent resin) as the binder for the color conversion layer 11, and a layer constituted by the phosphor 13 and the translucent resin.

The phosphor 13 is not limited to a particular one, but for example, there is a phosphor able to absorb light, and output light resulting from a conversion of the absorbed light to the one having a longer wavelength. As the phosphor 13, for example, there are a yellow phosphor which is excited by blue light to emit yellow light (yellow phosphor able to absorb blue light and output light of a color converted to a yellow side than the blue light), a green phosphor which is excited by blue light to emit green light (green phosphor able to absorb blue light and output light of a color converted to a green side than the blue light), and a red phosphor which is excited by blue light to emit red light (red phosphor able to absorb blue light and output light of a color converted to a red side than the blue light). As the yellow phosphor, for example, there are YAG and LSN. As the green phosphor, for example, there are β-SialON and LuAG. As the red phosphor, for example, there are KSF and CASN. A single kind among the phosphors 13 may be used, or two or more kinds thereof may be used in combination.

As the phosphor 13, as shown in FIGS. 1 to 4, the green phosphor 15 and the red phosphor 16 are preferably contained, and the phosphor 13 may be constituted by the green phosphor 15 and the red phosphor 16. For example, when the green phosphor 15 and the red phosphor 16 are contained, and light caused to pass through the optical sheet is a blue light, the blue light passing through the optical sheet is absorbed by a green phosphor 15 contained in the color conversion layer 11 of the optical sheet, whereby light having been converted to a green side than the blue light can be emitted from the green phosphor 15. Further, blue light passing through the optical sheet is absorbed by a red phosphor 16 contained in the color conversion layer 11 of the optical sheet, whereby light having been converted to a red side than the blue light can be emitted from the red phosphor 16. The converted lights of a mixed color are then converted to a yellow side. The lights having passed through the optical sheet are then converted to a white side by the mixture of these lights having been converted to a yellow side. Therefore, the optical sheet is capable of suitable color conversion. A content ratio of the green phosphor 15 to the red phosphor 16 varies also according to a kind of the phosphor 13 (the green phosphor 15 and the red phosphor 16), but is preferably between 6:3 and 6:18, more preferably between 6:6 and 6:12, and still more preferably 6:9 in terms of mass ratio. When the content ratio of the green phosphor 15 to the red phosphor 16 is between the above ranges, light having passed through the optical sheet can be suitably converted to a white side by the lights of the mixed color obtained upon striking the phosphor 13. Therefore, an optical sheet capable of more suitable color conversion is obtainable.

The content of the phosphor 13 varies also according to a thickness of the color conversion layer 11 and a kind of the phosphor 13, but for example, is preferably from 7.5 to 15 mass % of the entire amount of the color conversion layer 11. When the content of the phosphor 13 is excessively low, a suitable color conversion tends to be hardly achievable. Specifically, even though the optical sheet has a higher color conversion efficiency owing to the light diffusion particles 12 fixedly attached on the surface of the color conversion layer 11, when the content of the phosphor 13 is excessively low, the optical sheet is liable to hardly achieve a suitable color conversion. Even when the content of the phosphor 13 is excessively high, the color conversion effect exhibited by the phosphor 13 tends to saturate. A suitable color conversion is achievable even with an excessive content of the phosphor 13. However, this means that the demand of reducing the content of the phosphor will not be met. Therefore, according to the present embodiment, it is possible to obtain an optical sheet which can perform a suitable color conversion even with the above range of the content of the phosphor 13 by fixedly attaching the light diffusion particles 12 on the surface of the color conversion layer 11.

A particle diameter of the phosphor 13 is not limited to a particular one as long as the phosphor 13 contained in the optical sheet is able to achieve color conversion. The particle diameter of the phosphor 13 is, for example, preferably 5 to 100 μm, and more preferably 10 to 40 μm in terms of the volume average particle diameter. Both of a phosphor 13 excessively small and a phosphor 13 excessively large tend to hardly achieve a suitable color conversion. This is considered to be because an excessively small phosphor 13 is hardly hit by light passing through the optical sheet. Further, excessively large phosphors 13 are liable to be distant from one another, and are thus inferred to be hardly hit by light passing through the optical sheet. Therefore, when the phosphor 13 has a particle diameter within the range described above, the obtained optical sheet is able to more suitably perform color conversion. The volume average particle diameter of the phosphor 13 may be measured by a generally used particle size analyzer.

As the binder for the color conversion layer 11, for example, there is resin having translucency (translucent resin). As the translucent resin, for example, there are acrylic resin, polystyrene, polycarbonate, a methyl methacrylate-styrene copolymer, polyethylene terephthalate, polyethylene naphlate, cellulose acetate, and polyimide. Further, as the binder (the translucent resin) for the color conversion layer 11, ultraviolet (UV)-curable resin is preferably used. A single kind among the binders for the color conversion layer 11 may be used, or two or more kinds thereof may be used in combination. UV-curable resin is preferably used as the binder for the color conversion layer 11 because the color conversion layer 11 can be obtained by adding the phosphor 13, and the light diffusion agent 17 as needed, to uncured UV-curable resin, spreading the uncured UV-curable resin added with these components over a substrate, a light diffusion layer, or the like, and subjecting the resultant to UV irradiation. As the UV-curable resin, for example, there is UV-curable acrylic resin.

As described above, it is sufficient that the color conversion layer 11 contains the phosphor 13 and is able to transmit light, and as shown in FIGS. 3 and 4, the color conversion layer 11 may contain not only the phosphor 13 but also a light diffusion agent 17. Further, it is sufficient that the color conversion layer 11 contains the phosphor 13, and the color conversion layer 11 may not contain the light diffusion agent 17. However, the color conversion layer 11 preferably contains the light diffusion agent 17. As the color conversion layer 11 containing also the light diffusion agent 17, for example, there are a layer containing the phosphor 13, the light diffusion agent 17, and a binder (the translucent resin) for the color conversion layer 11, and a layer constituted by the phosphor 13, the light diffusion agent 17, and the binder (the translucent resin) for the color conversion layer 11. By containing not only the phosphor 13 but also the light diffusion agent 17, the color conversion layer 11 is able to perform a suitable color conversion even with a relatively low content of the phosphor 13. Specifically, in the optical sheet 30, 40 containing also the light diffusion agent 17 in the color conversion layer 11, the content of the phosphor 13 can be reduced to perform a color conversion of the same level as that in the case where no light diffusion agent is contained in the color conversion layer owing to the light diffusion agent 17 contained in the color conversion layer 11. This is considered to be attributed to the followings. Light passing through the optical sheet 30, 40 results in having a longer optical path through striking a light diffusion agent 17 contained in the color conversion layer 11 of the optical sheet 30, 40, and the like. Consequently, the light in transmission has more occasion to strike a phosphor 13. This is considered to realize suitable color conversion by the phosphor 13. This is the reason why a suitable color conversion is considered to be achievable even with a relatively low content of the phosphor 13.

The light diffusion agent 17 is not limited to a particular one as long as the light diffusion agent 17 contained in the optical sheet is able to exhibit an effect of diffusing light. As the light diffusion agent 17, for example, there are an inorganic particle and an organic particle contained as a light diffusion agent contained in a generally used light diffusion sheet. As the inorganic particle, for example, there are a silica particle, a titanium oxide particle, an aluminum hydroxide particle, and a barium sulfate particle. As the organic particle, for example, there are an acrylic particle, an acrylonitrile particle, a silicone bead, a polystyrene particle, and a polyamide particle. A single kind among the light diffusion agents may be used, or two or more kinds thereof may be used in combination. Among these, the silicone bead and the titanium oxide particle are preferable as the light diffusion agent 17. The color conversion layer 11 may contain the light diffusion agent 17, or may not contain the light diffusion agent 17 as described above. The content of the light diffusion agent 17, when the light diffusion agent 17 is contained, varies also according to a kind of the light diffusion agent 17, but for example, is preferably from 0.1 to 30 mass %, and more preferably from 0.5 to 30 mass % of the entire amount of the color conversion layer 11.

The thickness of the color conversion layer 11 varies also according to the concentration of the phosphor 13, and is not limited to a particular one. A lower limit value of the thickness of the color conversion layer 11 is, for example, preferably 10 μm or more, and more preferably 50 μm or more. An upper limit value of the thickness of the color conversion layer 11 is, for example, preferably 1,000 μm or less, and more preferably 500 μm or less, still more preferably 300 μm or less, and particularly preferably 200 μm or less. When the color conversion layer 11 is excessively thin, a color conversion effect by the color conversion layer 11 tends to be hardly exhibited enough. Both an excessively thin color conversion layer 11 and an excessively thick color conversion layer 11 are liable to cause inconvenience. For example, the obtained optical sheet is liable to have a lower moldability. Additionally, when the color conversion layer 11 is excessively thick, the obtained optical sheet is thicker, and more hardly contributes to the downsizing of a backlight unit and a liquid crystal display device being the final product.

Owing to the above-described configuration, the optical sheet is able to perform a suitable color conversion even with a relatively low content of the phosphor. As described above, the optical sheet may be used as an optical sheet arranged between a plurality of light sources separately provided to a rear of a display screen of a liquid crystal display device and a prism sheet.

A method for manufacturing the optical sheet is not limited to a particular one as long as the method allows the manufacture of the optical sheet having the above configuration. As a method for manufacturing the optical sheet, for example, there is a method for manufacturing an optical sheet including the light diffusion particles 12 fixedly attached on the color conversion layer 11 by spreading liquid binder 14 added with the light diffusion particles 12 over a surface of a color conversion layer 11 containing the phosphor 13, and solidifying the binder 14. When UV-curable resin is used as the binder 14, as a way of solidification, for example, there is a way of curing the binder by subjecting it to UV irradiation.

The backlight unit provided in the liquid crystal display device is not limited to a particular one as long as the backlight unit includes the optical sheet. Specifically, the backlight unit according to the present embodiment includes a plurality of light sources, a prism sheet, and an optical sheet arranged between the light sources and the prism sheet, the optical sheet being the one described above. The backlight unit including the optical sheet is able to emit light having been suitably color-converted. Specifically, the backlight unit 50 includes, as shown in FIG. 5, a reflective sheet 21, a plurality of light sources 22, the optical sheet 10, a first prism sheet 24, a second prism sheet 25, and a polarizing sheet 26. The light sources 22 are two-dimensionally arranged over the reflective sheet 21. The optical sheet 10 is an optical sheet according to the present embodiment, and is arranged between the light sources 22 and the first prism sheet 24. The first prism sheet 24 and the second prism sheet 25 are located between the optical sheet 10 and the polarizing sheet 26, wherein located closer to the optical sheet 10 is the first prism sheet 24, whereas located closer to the polarizing sheet 26 is the second prism sheet 25. Here, a case where the optical sheet 10 shown in FIG. 1 is used will be described. However, in place of the optical sheet 10, the optical sheet 20 shown in FIG. 2, the optical sheet 30 shown in FIG. 3, or the optical sheet 40 shown in FIG. 4 may be used.

The reflective sheet 21 is not limited to a particular one, and for example, there is a reflective sheet provided in a generally used backlight unit. As the reflective sheet 21, for example, there are a white polyethylene terephthalate resin-based film and a silver deposition film.

The light source 22 is not limited to a particular one, and for example, there is a light source provided in a generally used backlight unit. As the light source 22, a so-called small light source may be used, and for example, there are a light emitting diode (LED) element and a laser element. Among these, an LED element is preferably used as the light source 22 in terms of the costs, the productivity, and the like. Further, the light source 22 is preferably a blue LED element emitting blue light. The optical sheet is able to suitably perform color conversion of blue light emitted from the light source to white light and the like. Therefore, the backlight unit 50 is able to emit blue light from the light source, and output white light resulting from a suitable color conversion of the emitted blue light. Further, the light source 22 may have a rectangular shape in a plan view, and in this case, the length of a side is preferably from 10 μm to 20 mm, more preferably from 10 μm to 10 mm, and still more preferably from 50 μm to 5 mm. When an LED element is used as the light source 22, LED chips may be arranged on the reflective sheet 21 at specific intervals therebetween. Further, the LED may be mounted with a lens for regulating light output angle properties of the LED element being the light source 22.

The first prism sheet 24 and the second prism sheet 25 are not limited to a particular one, and for example, there is a prism sheet provided in a generally used backlight unit. As the first prism sheet 24 and the second prism sheet 25, for example, there is a film defined with a plurality of respectively adjacent grooves each having a form of an isosceles triangle in a cross-section, a pair of the adjacent grooves forming a prism with a vertical angle of roughly 90°. A more specific example of the first prism sheet 24 and the second prism sheet 25 is a polyethylene terephthalate (PET) film formed in a prism shape using UV-curable acrylic resin. The first prism sheet 24 and the second prism sheet 25 are arranged in such a manner that each groove defined in the first prism sheet 24 and each groove defined in the second prism sheet 25 are orthogonal to each other. The first prism sheet 24 and the second prism sheet 25 may be integrally combined with each other.

The polarizing sheet 26 is not limited to a particular one, and for example, there is a polarizing sheet provided in a generally used backlight unit. As the polarizing sheet 26, a commercial product may be used, and for example, there is DBEF series of 3M Company.

The liquid crystal display device is not limited to a particular one as long as the liquid crystal display device includes the backlight unit. Specifically, the liquid crystal display device according to the present embodiment includes the backlight unit, and a liquid crystal panel provided to the prism sheet of the backlight unit. In the liquid crystal display device, suitably converted light is emitted from the backlight unit including the optical sheet. Therefore, the liquid crystal display device is able to suitably display an image on the liquid crystal panel. As shown in FIG. 6, the liquid crystal display device 60 includes a backlight unit 50, a liquid crystal panel 35, a first polarizing plate 36, and a second polarizing plate 37. The liquid crystal panel 35 is located between the first polarizing plate 36 and the second polarizing plate 37, wherein provided closer to the backlight unit 50 is the first polarizing plate 36.

The liquid crystal panel 35 includes a thin-film transistor (TFT) substrate 31 and a color filter (CF) substrate 32 arranged opposite to each other, and a liquid crystal layer 33 arranged between the TFT substrate 31 and the CF substrate 32. The liquid crystal panel 35 further includes a sealing material (not shown) having a frame shape for encapsulating the liquid crystal layer 33 between the TFT substrate 31 and the CF substrate 32.

The TFT substrate 31 is not limited to a particular one, and there is, for example, a TFT substrate provided in a generally used liquid crystal display device. As the TFT substrate 31, for example, there is a substrate including a glass substrate, a plurality of TFTs provided in a matrix shape over the glass substrate, an interlayer insulating film provided so as to cover each of the TFTs, a plurality of pixel electrodes which are provided in a matrix form over the interlayer insulating film and are connected to the TFTs, respectively, and an alignment film provided so as to cover each of the pixel electrodes.

The CF substrate 32 is not limited to a particular one, and there is, for example, a CF substrate provided in a generally used liquid crystal display device. As the CF substrate 32, for example, there is a substrate including a glass substrate, a black matrix provided in a lattice pattern over the glass substrate, a color filter including a red layer, a green layer, and a blue layer provided in lattice cells of the black matrix, respectively, a common electrode provided so as to cover the black matrix and the color filter, and an alignment film provided so as to cover the common electrode.

The liquid crystal layer 33 is not limited to a particular one, and there is, for example, a liquid crystal layer or the like provided in a generally used liquid crystal display device. As the liquid crystal layer 33, for example, there is a liquid crystal layer composed of a nematic liquid crystal material or the like including a liquid crystal molecule having electro-optical properties.

The first polarizing plate 36 and the second polarizing plate 37 are not limited to a particular one, and there is, for example, a polarizing plate or the like provided in a generally used liquid crystal display device. As the first polarizing plate 36 and the second polarizing plate 37, for example, there is a polarizing plate including a polarizer layer having a polarization axis in one direction and a pair of protective layers provided so as to sandwich the polarizer layer.

The shape of the display screen 60a of the liquid crystal display device 60 in a front view (from above in FIG. 5) is not limited to a particular one. The shape is often rectangular or square, but is not limited thereto, and may be of a desired shape such as a rectangular shape with rounded corners, an oval shape, a circular shape, a trapezoid, or a form of an instrument panel of an automobile.

The liquid crystal display device 60 changes an alignment state of the liquid crystal layer 33 by applying a voltage of a predetermined magnitude to the liquid crystal layer 33 in each sub-pixel corresponding to each of the pixel electrodes, adjusts the transmittance of light incident from the backlight unit 50 through the first polarizing plate 36, and emits the adjusted light through the second polarizing plate 37, whereby an image is displayed.

The liquid crystal display device 60 is used as a display device to be incorporated in various information devices (e.g., an on-vehicle device such as a car navigation system, a personal computer, a mobile phone, a mobile information terminal, a mobile gaming device, a copy machine, a ticket vending machine, and an automated teller machine, etc.)

The present specification discloses technologies including various configurations as described above. The main technologies thereof are summarized hereinafter.

An aspect of the present invention is directed to an optical sheet including a color conversion layer containing a phosphor, and a plurality of light diffusion particles fixedly attached on at least one surface of the color conversion layer.

According to the configuration, an optical sheet capable of suitable color conversion can be provided. Specifically, in the optical sheet, the content of the phosphor can be reduced to perform a color conversion of the same level as a case where light diffusion particles are not fixedly attached on the surface thereof. Therefore, the optical sheet is able to perform such a suitable color conversion that a suitable color conversion is achievable even with a relatively low content of the phosphor.

Further, in the optical sheet, the light diffusion particle is preferably at least one of a glass bead and a resin bead. Further, the resin bead may be more preferably a hollow particle containing a styrene-based resin.

According to the configuration, an optical sheet capable of more suitable color conversion can be provided.

In the optical sheet, the light diffusion particles may preferably have a volume average particle diameter of 0.1 to 5 μm.

According to the configuration, an optical sheet capable of more suitable color conversion can be provided.

Further, in the optical sheet, it may be appreciated that the light diffusion particles are fixedly attached on the color conversion layer by a resin, and a ratio of the light diffusion particles to the resin is from 10 to 300 mass %.

According to the configuration, an optical sheet capable of more suitable color conversion can be provided.

Further, in the optical sheet, the light diffusion particles may be preferably fixedly attached on both surfaces of the color conversion layer.

According to the configuration, an optical sheet capable of more suitable color conversion can be provided.

Further, in the optical sheet, the phosphor may preferably include a green phosphor and a red phosphor.

According to the configuration, an optical sheet capable of more suitable color conversion can be provided. Specifically, when light passing through the optical sheet is blue light, the blue light passing through the optical sheet is absorbed by the green phosphor contained in the color conversion layer of the optical sheet, whereby light resulting from a conversion of the blue light to a green side can be emitted from the green phosphor. Further, blue light passing through the optical sheet is absorbed by the red phosphor contained in the color conversion layer of the optical sheet, whereby light resulting from a conversion of the blue light to a red side can be emitted from the red phosphor. These converted lights of a mixed color are then converted to a yellow side. Accordingly, the blue light having passed through the optical sheet is then converted to a white side by the mixed lights having been converted to the yellow side. Therefore, the optical sheet is capable of suitable color conversion.

In the optical sheet, the color conversion layer may preferably further contain a light diffusion agent.

According to the configuration, an optical sheet capable of suitable color conversion even with a relatively low content of the phosphor can be obtained. Specifically, the content of the phosphor can be reduced to perform a color conversion of the same level as an optical sheet not containing a light diffusion agent.

Further, in the optical sheet, the light diffusion agent may preferably include at least one of a silicone bead and a titanium oxide particle.

According to the configuration, the content of the phosphor can be further reduced to perform a color conversion of the same level as an optical sheet not containing a light diffusion agent. Therefore, an optical sheet having more excellent color convertibility can be obtained.

Further, the optical sheet may be preferably arranged in a liquid crystal display device including a plurality of light sources separately provided to a rear of a display screen between the light sources and a prism sheet.

According to the configuration, a liquid crystal display device performing suitable image display is obtainable by adopting the optical sheet to the liquid crystal display device.

Further, another aspect of the present invention is directed to a backlight unit including a plurality of light sources, a prism sheet, and an optical sheet arranged between the light sources and the prism sheet, wherein the optical sheet is the one described above.

According to the present configuration, a backlight unit capable of emitting suitably color-converted light can be provided.

Further, in the backlight unit, the light source may be preferably a light-emitting diode element emitting blue light.

According to the present configuration, a backlight unit capable of emitting blue light from the light source, and outputting white light resulting from a suitable color conversion of the emitted blue light can be provided.

Further, a still another aspect of the present invention is directed to a liquid crystal display device including the backlight unit, and a liquid crystal panel provided to the prism sheet of the backlight unit.

According to the present configuration, light suitably color-converted is emitted from the backlight unit, whereby a liquid crystal display device capable of performing suitable image display on the liquid crystal panel is obtainable.

According to the present invention, an optical sheet which is capable of suitable color conversion, a backlight unit including the optical sheet, and a liquid crystal display device including the backlight unit can be provided.

Hereinafter, the present invention will be further specifically described by means of Examples. However, the scope of the present invention should not be limited thereto.

### EXAMPLES

### Production of Color Conversion Layer

Green phosphors (β-SiAlON, volume average particle diameter of 16 μm) and red phosphors (KSF, volume average particle diameter of 30 μm) were added to uncured (liquid) UV-curable resin (UV-curable acrylic resin) in such a way that the green phosphors and the red phosphors constitute 6 mass % and 9 mass %, respectively. The content of the phosphors was 15 mass % as a total of the green phosphors and the red phosphors. The thus-obtained liquid (color conversion layer-forming coating liquid) was spread over a substrate. Here, the color conversion layer-forming coating liquid was spread in such a way that the finally-obtained color conversion layer has a thickness of roughly 130 μm. Thereafter, the spread color conversion layer-forming coating liquid was subjected to UV irradiation to thereby cure the UV-curable resin. As a result, the substrate was formed with a color conversion layer, which was then peeled off from the substrate to thereby produce the color conversion layer.

### Review Examples

First, the following particles were used as the light diffusion particles.

Glass beads 1: Glass beads (UBS-0005E manufactured by UNITIKA Ltd., volume average particle diameter: 3.76 μm)

Glass beads 2: Glass beads (UBS-0005MF manufactured by UNITIKA Ltd., volume average particle diameter: 3.40 μm)

Acrylic beads: Acrylic beads (RUBCOULEUR 2307MEJ manufactured by Dainichiseika Color & Chemicals Mfg. Co., Ltd., volume average particle diameter: 7 μm)

Hollow styrene particles 1: hollow particles made of polystyrene (xx284 manufactured by Sekisui Kasei Co., Ltd., multi-hollow particles, volume average particle diameter: 7.5 μm)

Hollow styrene particles 2: hollow particles made of polystyrene (xx301 manufactured by Sekisui Kasei Co., Ltd., single-hollow particles, volume average particle diameter: 4.5 μm)

Hollow styrene particles 3: hollow particles made of polystyrene (xx306 manufactured by Sekisui Kasei Co., Ltd., single-hollow particles, volume average particle diameter: 0.4 μm)

### Review Example 1

Light diffusion particles (glass beads 1) shown in Table 1 were dispersed in a binder (thermosetting acrylic resin, A807-BA manufactured by DIC Corporation). Here, the resultant was mixed in such a way that a ratio of the light diffusion particles to the binder (light diffusion particles/binder) was 60 mass %. The obtained dispersion liquid was spread over a PET sheet in such a way that the light diffusion particles cover the entire surface of the PET sheet. Thereafter, the resultant was let stand for one minute under the condition of the temperature of 80° C. to thereby cure the binder. As a result, the light diffusion particles were fixedly attached onto the PET sheet.

As Review Example 1, a laminated body including this PET sheet attached with the light diffusion particles arranged over the color conversion layer was used.

### Review Examples 2 to 6

As Review Examples 2 to 6, laminated bodies obtained in the same manner as Review Example 1 except that the light diffusion particles (glass beads 1) are replaced with light diffusion particles respectively shown in Table 1 were used.

### Review Example 7

As Review Example 7, a laminated body obtained in the same manner as Review Example 1 apart from not using the light diffusion particles were used.

### Evaluation

### Chromaticity

A backlight unit was assembled by arranging a measurement target (the laminated body) at a distance of 5 mm from upper surfaces of arrayed blue LED elements (blue LED array), and laying, over the measurement target, two prism sheets superposed in such a way as to have respective grooves orthogonal to one another. The chromaticity (x, y) of light emitted from the backlight unit was measured by a luminance meter (Spectroradiometer SR-3 manufactured by Topcon Technohouse Corporation).

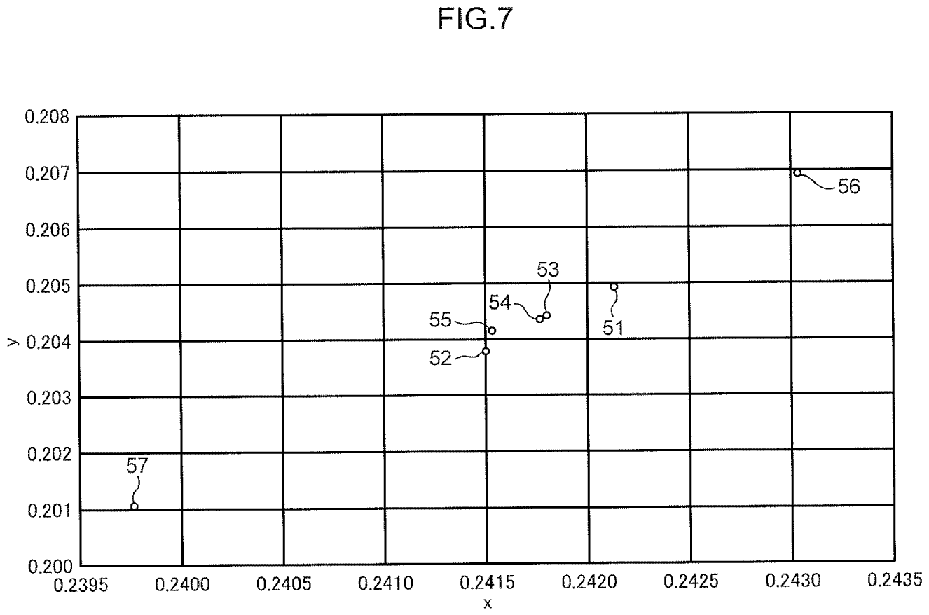

The results thereof are shown in Table 1 and FIG. 7. FIG. 7 is a graph showing a relationship between a kind of light diffusion particles fixedly attached on an optical sheet and a chromaticity. In FIG. 7, plotted points 51 to 57 show the results of Review Examples 1 to 7, respectively.

TABLE 1

| | | Chromaticity | |
|---|---|---|---|
| | Light diffusion particles | x | y |
| Review Example 1 | Glass beads 1 | 0.2421 | 0.2049 |
| Review Example 2 | Glass beads 2 | 0.2415 | 0.2038 |
| Review Example 3 | Acrylic beads | 0.2418 | 0.2044 |
| Review Example 4 | Hollow styrene particles 1 | 0.2418 | 0.2043 |
| Review Example 5 | Hollow styrene particles 2 | 0.2415 | 0.2041 |
| Review Example 6 | Hollow styrene particles 3 | 0.2430 | 0.2069 |
| Review Example 7 | — | 0.2398 | 0.2011 |

Table 1 and FIG. 7 show that blue light can be converted to light closer to white in cases where a PET sheet fixedly attached with light diffusion particles is laid over a color conversion layer containing a phosphor (Review Examples 1 to 6) compared with a case where a PET sheet not fixedly attached with light diffusion particles is laid thereover (Review Example 7). This indicates that a suitable color conversion is achievable when light diffusion particles are fixedly attached onto a color conversion layer.

Further, it was found that more effective color conversion was achievable when the hollow styrene particles 3 (xx306) were used (Review Example 6). This shows that the smaller the light scattering particles used are, the more suitable color conversion the optical sheet is able to perform. Specifically, the use of small hollow particles (for example, of 1 μm or less) enables a higher color conversion efficiency compared with cases where the hollow styrene particles 1 and the hollow styrene particles 2 are used (Review Example 4 and Review Example 5). In contrast, the color conversion efficiencies in the cases where the hollow styrene particles 1 and the hollow styrene particles 2 were used (Review Example 4 and Review Example 5) were substantially the same as those of the glass beads 1, the glass beads 2, and the acrylic beads (Review Examples 1 to 3). This teaches that the particle diameter of the light diffusion particles considerably affects the color conversion efficiency. This is considered to be attributed to the following. Since the light diffusion particles have small particle diameters, the light diffusion particles are liable to occupy a larger surface area per unit mass, thereby allowing blue light to strike them more frequently. This is why the light diffusion particles are considered to particularly enhance the effect of increasing the striking frequency of a phosphor contained in the color conversion layer. Therefore, it is inferred that the smaller the particle diameter of the light diffusion particle is, the more the color convertibility can be increased in the optical sheet.

Accordingly, we further studied as below using the hollow styrene particles 3 (xx306).

### Examples 1 to 3

The hollow styrene particles 3 (xx306) were dispersed in the binder (thermosetting acrylic resin, A807-BA manufactured by DIC Corporation) as the light diffusion particles. Here, the resultant was mixed in such a way that ratios of the light diffusion particles to the binder (light diffusion particles/binder) meet the percentages (light diffusion particles/binder: mass %) shown in Table 2. The obtained dispersion liquid was spread over one surface (surface on the light output side) of the color conversion layer in such a way that the light diffusion particles cover the entire surface of the color conversion layer. Thereafter, the resultant was let stand for one minute under the condition of the temperature of 80° C. to thereby cure the binder. As a result, optical sheets fixedly attached with the light diffusion particles on one surface of the respective light conversion layers were obtained. The coverage ratio of the particles to the color conversion layer was 100%.

### Examples 4 to 6

The hollow styrene particles 3 (xx306) were dispersed in the binder (thermosetting acrylic resin, A807-BA manufactured by DIC Corporation) as the light diffusion particles. Here, the resultant was mixed in such a way that ratios of the light diffusion particles to the binder (light diffusion particles/binder) meet the percentage (light diffusion particles/binder) of 100 mass %. The obtained dispersion liquid (first dispersion liquid) was spread over one surface (surface on the light output side) of the color conversion layer in such a way that the light diffusion particles cover the entire surface of the color conversion layer. Thereafter, the resultant was let stand for one minute under the condition of the temperature of 80° C. to thereby cure the binder.

Next, apart from the first dispersion liquid, hollow styrene particles 3 (xx306) were mixed with the binder as the light diffusion particles in such a way that ratios (light diffusion particles/binder) meet the percentages (light diffusion particles/binder: mass %) shown in Table 2. The obtained dispersion liquid (second dispersion liquid) was spread over another surface (surface on the light input side) of the color conversion layer in such a way that the light diffusion particles cover the entire surface of the color conversion layer. Thereafter, the resultant was let stand for one minute under the condition of the temperature of 80° C. to thereby cure the binder. As a result, optical sheets fixedly attached with the light diffusion particles on both the surfaces of the respective light conversion layers were obtained. The coverage ratio of the particles to the color conversion layer was 100%.

### Comparative Example

The optical sheet according to Comparative Example was obtained in the same manner as Example 1 apart from not using the light diffusion particles.

### Evaluation

### Chromaticity

The thus-obtained optical sheets were respectively arranged in such a way that the surfaces on the light output side are closer to the prism sheets, whereby chromaticities of the optical sheets were measured as the measurement target in the chromaticity measurement method.

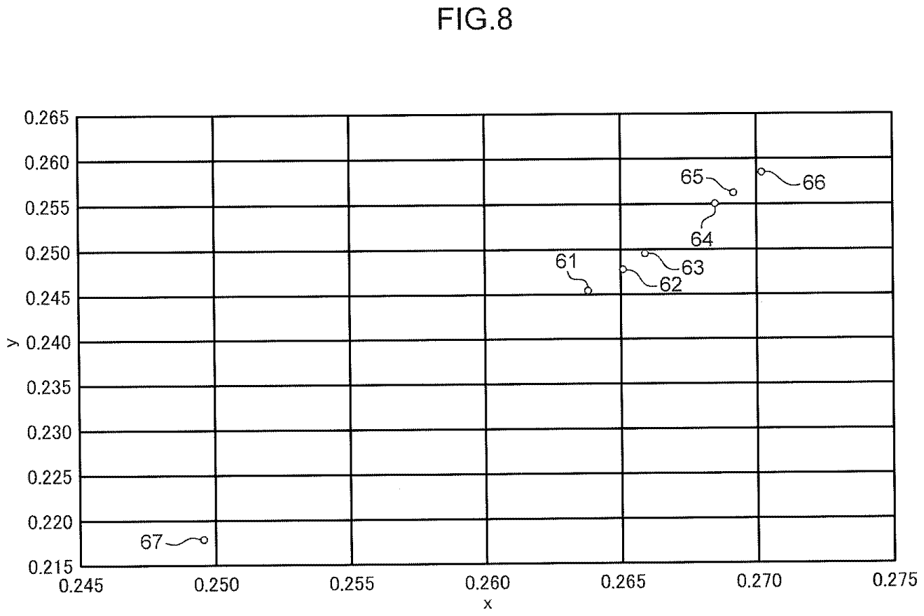

The results thereof are shown in Table 2 and FIG. 8. FIG. 8 is a graph showing a relationship between a configuration of an optical sheet and a chromaticity. In FIG. 8, plotted points 61 to 67 show the results of Examples 1 to 6 and Comparative Example 1, respectively.

TABLE 2

| | | Light diffusion particles/binder | | | |
|---|---|---|---|---|---|
| | | (mass %) | | | |
| | Light | Light | Light | | |
| | diffusion | output | input | Chromaticity | |
| | particles | side | side | x | y |
| Example 1 | Only on one side | 60 | — | 0.2638 | 0.2455 |
| Example 2 | (light output side) | 80 | — | 0.2651 | 0.2478 |
| Example 3 | | 100 | — | 0.2659 | 0.2496 |
| Example 4 | On both sides | 100 | 60 | 0.2684 | 0.2551 |
| Example 5 | | 100 | 80 | 0.2691 | 0.2563 |
| Example 6 | | 100 | 100 | 0.2701 | 0.2585 |
| Comparative | — | | | 0.2497 | 0.2182 |
| Example | | | | | |

As shown in Table 2 and FIG. 8, in cases where light diffusion particles were fixedly attached onto the color conversion layers (Examples 1 to 6), color was more suitably converted compared with a case where the layer was not fixedly attached with light diffusion particles (Comparative Example). Further, in cases where light diffusion particles were fixedly attached onto both surfaces of the color conversion layers (Examples 4 to 6), color was more suitably converted compared with cases involving only one of the surfaces (Examples 1 to 3). This shows that the light diffusion particles are preferably fixedly attached onto both surfaces of the color conversion layer. Further, a comparison among Examples 1 to 3 indicates that when the ratio of the light diffusion particles to the binder is higher, color is more suitably converted. A comparison among Examples 4 to 6 also indicates the same. Consequently, it can be understood from above that, when the light diffusion particles can be fixedly attached onto a color conversion layer, a greater amount of light diffusion particles may be preferably attached.

When a color conversion layer was made to contain silicone beads having a volume average particle diameter of 2 μm in each of the optical sheets of Examples 1 to 6 as a light diffusion agent, the respective chromaticities (x, y) of the obtained light were higher than those of the optical sheets of Examples 1 to 6.

Further, when a color conversion layer was made to contain titanium oxide particles having a volume average particle diameter of 0.05 μm in each of the optical sheets of Examples 1 to 6 as the light diffusion agent, the respective chromaticities (x, y) of the obtained light were higher than those of the optical sheets of Examples 1 to 6.

The results show that, owing to the light diffusion agent contained in the color conversion layer, the chromaticity (x, y) of the obtained light can be further increased, and consequently, a still more suitable color conversion is achievable.

Further, Examples show that a greater reduction of phosphor is achievable compared with Comparative Example. Specifically, using data of Example 6 and Comparative Example, the following calculation can be made.

Chromaticity Difference from Blue Light: Δx, Δy

A difference (Δx, Δy) between the chromaticity (x, y) of the obtained light and the chromaticity (x_B, y_B) of the light emitted from the blue LED element was calculated by the following equations. Here, the difference (Δx, Δy) from the chromaticity (x_B, y_B) of the light emitted from the blue LED element was deemed as the chromaticity difference from the blue light.

Δx=x−x_B

Δy=y−y_B

The light emitted from the blue LED element had the chromaticity (x_B, y_B), where x_B was 0.1535 and y_B was 0.0269.

### Reducible Rate

First, a difference in the chromaticity from the blue light was estimated on the assumption that the chromaticity from the blue light is directly proportional to the concentration of the phosphor, and the color convertibility was obtained on the basis thereof. Specifically, the color convertibility was calculated by the following equation using a chromaticity difference (Δx_e, Δy_e) from the blue light in the optical sheet of Example 6 and a chromaticity difference (Δx_c, Δy_c) from the blue light in the optical sheet of Comparative Example.

Color Convertibility (%)=0.5×(Δx_e/Δx_c+Δy_e/Δy_c)×100

Next, the phosphor reducible rate was calculated by dividing 100 by the color convertibility.

TABLE 3

| | | | Difference from | | Color | |
|---|---|---|---|---|---|---|
| | | | blue light | | convert- | Reducible |
| | Chromaticity | | in Chromaticity | | ibility | Rate |
| | x | y | Δ x | Δ y | (%) | (%) |
| Example 6 | 0.2701 | 0.2585 | 0.1166 | 0.2316 | 121.1 | 17.4 |
| Comparative | 0.2497 | 0.2182 | 0.0962 | 0.1913 | — | |
| Example | | | | | | |

As shown in Table 3, the optical sheet of Example 6 is estimated to achieve a reduction of 17.4% in the use amount of the phosphor to obtain the chromaticity of the same level as the optical sheet of Comparative Example not fixedly attached with the light diffusion particles.

This application is based on Japanese Patent Application No. 2020-163602 filed on Sep. 29, 2020, the contents of which are incorporated in the present application.

While the present invention has been fully and appropriately described in the above by way of embodiments in order to express the present invention, it is to be recognized that those skilled in the art can readily change and/or modify the embodiments described above. Therefore, it is to be construed that the changes or modifications made by those skilled in the art are encompassed within the scope of the claims unless those changes or modifications are at a level that departs from the scope of the claims described in the claims section of the present application.

### INDUSTRIAL APPLICABILITY

According to the present invention, an optical sheet which is able to perform a suitable color conversion, a backlight unit including the optical sheet, and a liquid crystal display device including the backlight unit are provided.

1. An optical sheet, comprising:
a color conversion layer containing a phosphor; and
a plurality of light diffusion particles fixedly attached on at least one surface of the color conversion layer.

2. The optical sheet according to claim 1, wherein
the light diffusion particle is at least one of a glass bead and a resin bead.

3. The optical sheet according to claim 2, wherein
the resin bead is a hollow particle containing a styrene-based resin.

4. The optical sheet according to claim 1, wherein
the light diffusion particles have a volume average particle diameter of 0.1 to 5 μm.

5. The optical sheet according to claim 1, wherein
the light diffusion particles are fixedly attached on the color conversion layer by a resin, and
a ratio of the light diffusion particles to the resin is from 10 to 300 mass %.

6. The optical sheet according to claim 1, wherein
the light diffusion particles are fixedly attached on both surfaces of the color conversion layer.

7. The optical sheet according to claim 1, wherein
the phosphor includes a green phosphor and a red phosphor.

8. The optical sheet according to claim 1, wherein
the color conversion layer further contains a light diffusion agent.

9. The optical sheet according to claim 8, wherein
the light diffusion agent includes at least one of a silicone bead and a titanium oxide particle.

10. The optical sheet according to claim 1, which is an optical sheet arranged between a plurality of light sources separately provided to a rear of a display screen of a liquid crystal display device and a prism sheet.

11. A backlight unit, comprising:
a plurality of light sources;
a prism sheet; and
an optical sheet arranged between the light sources and the prism sheet, wherein
the optical sheet is an optical sheet according to claim 1.

12. The backlight unit according to claim 11, wherein
the light source includes a light-emitting diode element emitting a blue light.

13. A liquid crystal display device, comprising:
the backlight unit according to claim 11, and
a liquid crystal panel provided to the prism sheet of the backlight unit.
